(19) United States
(12) Patent Application Publication
(10) Pub. No.: US 2021/0021760 A1
(43) Pub. Date: Jan. 21, 2021

(54) UNMANNED AERIAL VEHICLE WITH PANORAMIC CAMERA

(71) Applicant: SZ DJI TECHNOLOGY CO., LTD., Shenzhen (CN)

(72) Inventors: Yifen LIU, Shenzhen (CN); Zhuo GUO, Shenzhen (CN)

(21) Appl. No.: 17/033,866

(22) Filed: Sep. 27, 2020

Related U.S. Application Data
(63) Continuation of application No. PCT/CN2018/080905, filed on Mar. 28, 2018.

(51) Int. Cl. H04N 5/232; H04N 5/225; H04N 5/247; B64C 39/02; B64D 47/08; B64C 27/00

(52) U.S. Cl. CPC H04N 5/23238; H04N 5/2253; H04N 5/2254; H04N 5/247; B64C 2201/127; B64D 47/08; B64C 27/006; B64C 2201/027; B64C 2201/108; B64C 39/024

(57) ABSTRACT

An unmanned aerial vehicle (UAV) includes a main body and a panoramic camera. The main body includes an upper surface and a lower surface. An accommodation hole is provided at the main body and penetrates the upper surface and the lower surface. The panoramic camera includes a camera connector, an upper lens, and a lower lens. The camera connector detachably mounts the panoramic camera to at least one of the accommodation hole or an outer periphery of the main body. The upper lens is arranged above the upper surface of the UAV. The lower lens is arranged below the lower surface of the UAV.

### CROSS-REFERENCE TO RELATED APPLICATION

This application is a continuation of International Application No. PCT/CN2018/080905, filed Mar. 28, 2018, the entire content of which is incorporated herein by reference.

### TECHNICAL FIELD

The present disclosure generally relates to the unmanned aerial vehicle (UAV) technology field and the panoramic camera field and, more particularly, to a modular combination of a panoramic camera and a UAV.

### BACKGROUND

The existing solution for mounting a panoramic camera at an unmanned aerial vehicle (UAV) mainly includes hanging the panoramic at the top of the UAV body or at the bottom of the UAV body, which causes the UAV body to block a large part of a field of view. Thus, an image captured by the panoramic camera cannot form a complete sphere, and a part of the field of view is always blocked by the UAV body.

As the UAV market develops quickly, obstacle avoidance technology, which may increase flight safety for the UAV, is quickly developed. During the flight, the UAV may collect surrounding information and detect a distance to generate a corresponding movement instruction to avoid an obstacle.

An obstacle avoidance function as a major trend for a UAV product provides a most direct benefit that some collisions caused by human negligence in the past can now be avoided by the obstacle avoidance function. That is, the flight safety of the UAV is ensured, and damage to surrounding personnel and property is avoided, such that a threshold for the flight of the UAV is further lowered.

The obstacle avoidance technology of the UAV most commonly includes an infrared sensor, an ultrasonic sensor, a laser sensor, and a vision sensor.

Binocular stereo vision is an important form of machine vision based on the parallax principle. Two images of a measured object are obtained from different positions by using an imaging device. Then, the three-dimensional geometric information of the object and the distance between the camera and the measured object are obtained by calculating the position deviation between the corresponding points of the image. A visual recognition system may usually include one or two cameras. A single image only has two-dimensional (2D) information, such as a 2D movie. The binocular stereo vision is like a 3D movie, which may directly give people a strong sense of spatial presence. The basic principle of the binocular stereo vision includes using two parallel cameras for photographing, calculating a distance between specific points using a series of complex algorithms according to differences between the two images, and when data is sufficient, generating a depth map. Through the front and rear binoculars and downward-looking binoculars, a surrounding terrain may be constructed and recorded in real-time, explicitly a local map and a global map may be generated.

Although binocular recognition has a powerful function, a certain limitation may still exist. At present, omnidirectional obstacle avoidance is still difficult to achieve based on the binocular stereo vision. The main reason is that after a visual receiving system processes boundary points, boundaries may overlap with each other. Therefore, a deviation in a calculation result may be caused to report an error.

It is desirable to adjust the position of the panoramic camera at the UAV to improve an obstacle avoidance ability for the UAV.

### SUMMARY

Embodiments of the present disclosure provide an unmanned aerial vehicle (UAV) including a main body and a panoramic camera. The main body includes an upper surface and a lower surface. An accommodation hole is provided at the main body and penetrates the upper surface and the lower surface. The panoramic camera includes a camera connector, an upper lens, and a lower lens. The camera connector detachably mounts the panoramic camera to at least one of the accommodation hole or an outer periphery of the main body. The upper lens is arranged above the upper surface of the UAV. The lower lens is arranged below the lower surface of the UAV.

Embodiments of the present disclosure provide an unmanned aerial vehicle (UAV) including a main body and a panoramic camera. The main body includes an upper surface and a lower surface. The panoramic camera includes a camera connector, an upper lens, and a lower lens. The camera connector detachably mounts the panoramic camera to an outer periphery of the main body. The upper lens is arranged above the upper surface of the UAV. The lower lens is arranged below the lower surface of the UAV.

### BRIEF DESCRIPTION OF THE DRAWINGS

FIG. 1 is a schematic diagram showing a panoramic camera connected to an unmanned aerial vehicle (UAV).

FIG. 2 is a schematic diagram showing a principle of the panoramic camera mounted at the UAV.

FIGS. 3A-3G are schematic diagrams showing a panoramic camera according to some embodiments of the present disclosure.

FIGS. 4A-4E are schematic diagrams showing a UAV according to some embodiments of the present disclosure.

FIGS. 5A-5D are schematic diagrams showing a panoramic camera module mounted at an accommodation hole of a main body of the UAV according to some embodiments of the present disclosure.

FIG. 6 is a schematic diagram showing the UAV mounted with the panoramic camera module of FIGS. 5A-5D, where light enters the panoramic camera module.

FIGS. 7A-7E are schematic diagrams showing a panoramic camera module mounted at an outer periphery of a main body of a UAV according to some embodiments of the present disclosure.

FIG. 8 is a schematic diagram showing the UAV mounted with the panoramic camera module of FIGS. 7A-7E, where light enters the panoramic camera module.

FIG. 9 is a partial enlarged view showing a status of the panoramic camera before being connected to the main body of the UAV according to some embodiments of the present disclosure.

FIG. 10 is a partial enlarged view showing a portion of FIG. 9 being further enlarged, and shows a structure when the panoramic camera is connected to the main body of the UAV.

FIG. 11 is a schematic diagram showing visual obstacle avoidance.

### DETAILED DESCRIPTION OF THE EMBODIMENTS

Embodiments of the present disclosure are described with reference to accompanying drawings. This description is merely exemplary and does not limit the scope of the present disclosure. In the following description, well-known structure and technology are omitted to avoid unnecessarily obscuring the concept of the present disclosure.

The terms used here are only for describing specific embodiments and are not intended to limit the present disclosure. The terms “including,” “containing,” etc., used herein indicate the existence of the described features, steps, operations, and/or components, but do not exclude the existence or addition of one or more other features, steps, operations, or components.

All terms (including technical and scientific terms) used herein have the meanings commonly understood by those skilled in the art, unless otherwise defined. The terms used herein should be interpreted as having meanings consistent with the context of this specification and should not be interpreted in an idealized or overly rigid manner.

An expression similar to “at least one of A, B, and C” should be interpreted according to the meaning of the expression commonly understood by those skilled in the art (for example, “a system including at least one of A, B, and C” should include but is not limited to a system including A alone, a system including B alone, a system including C alone, a system including A and B, a system including A and C, a system including B and C, and/or a system including A, B, and C). An expression similar to “at least one of A, B, or C” should be interpreted according to the meaning of the expression commonly understood by those skilled in the art (for example, “a system including at least one of A, B, or C” should include but is not limited to a system including A alone, a system including B alone, a system including C alone, a system including A and B, a system including A and C, a system including B and C, and/or a system including A, B, and C). Those skilled in the art should also understand that essentially any transitional conjunctions and/or phrases representing two or more optional items, whether in the description, claims, or drawings, should be understood to have possibilities of including one of these items, any one of these items, or two items. For example, the phrase “A or B” should be understood to include the possibilities of “A,” “B,” or “A and B.”

An unmanned aerial vehicle (UAV) described below includes, for example, a fixed-wing aircraft, or a rotary-wing aircraft, such as a helicopter, a quadcopter, or an aircraft with another number of rotors and/or another rotor structure. The UAV is provided with an image acquisition device configured to collect a target image, for example, to take a photo, record a video, etc.

A technology, which is related to a photographing parameter setting when the UAV performs an aerial photographing task, is described.

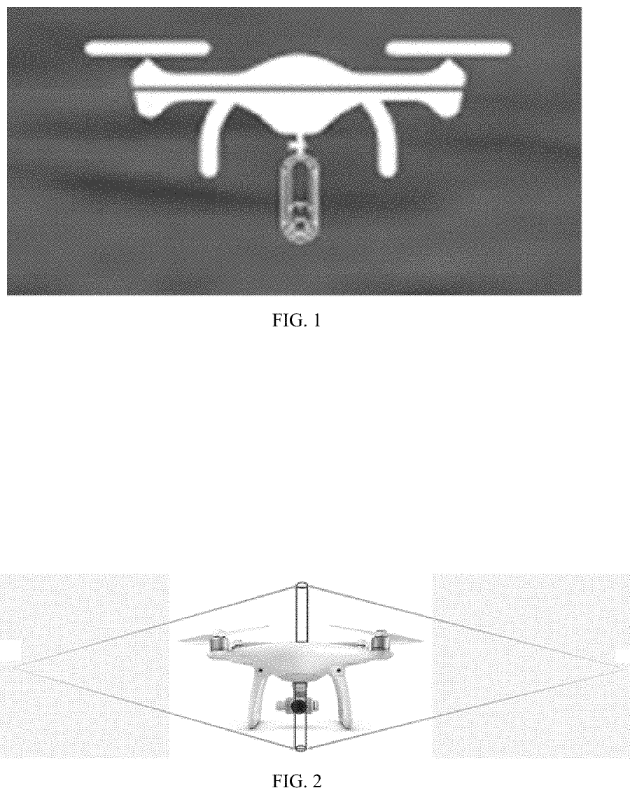

FIG. 1 is a schematic diagram showing a panoramic camera connected to an unmanned aerial vehicle (UAV).

FIG. 2 is a schematic diagram showing a principle of the panoramic camera mounted at the UAV.

FIG. 1 only shows an example application scenario consistent with the present disclosure, which does not mean that embodiments of the present disclosure cannot be applied to other devices, systems, environments, or scenarios.

As shown in FIG. 1, an image acquisition device is provided at the UAV. In some embodiments, the image acquisition device may include one or more optical devices, which may affect light reaching a focus point at an imaging sensor. In some embodiments, the image acquisition device may include, for example, a semiconductor charge-coupled device (CCD), a complementary metal-oxide-semiconductor (CMOS), and/or an N-type metal oxide semiconductor (NMOS, LiveMOS). In some embodiments, the image acquisition device may be configured to capture a high definition (HD) or Ultra HD video (e.g., 720p, 1080i, 1080p, 1440p, 2000p, 2160p, 2540p, 4000p, 4320p, etc.).

In the present disclosure, an obstacle avoidance ability of the UAV can be improved by adjusting a setting position of the panoramic camera at the UAV.

The present disclosure provides two modules: a panoramic camera module (including two lenses (top and bottom) each with a field of view larger than 180°) and a UAV. The panoramic camera may be used alone. When the panoramic camera module is combined with the UAV to become a flying panoramic camera, a surrounding environment may be viewed without a blind spot.

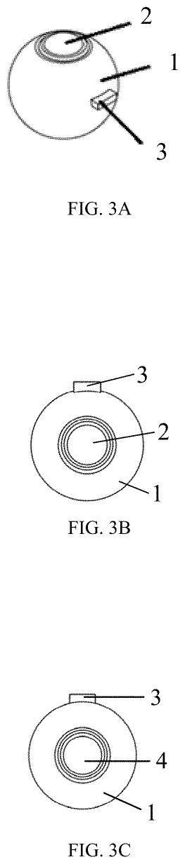

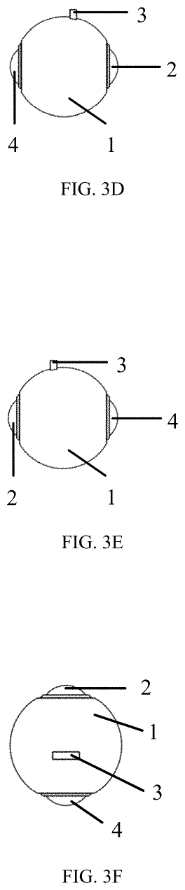

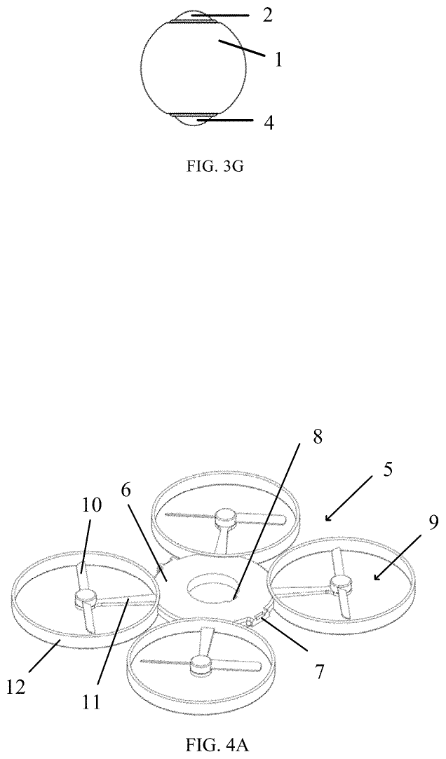

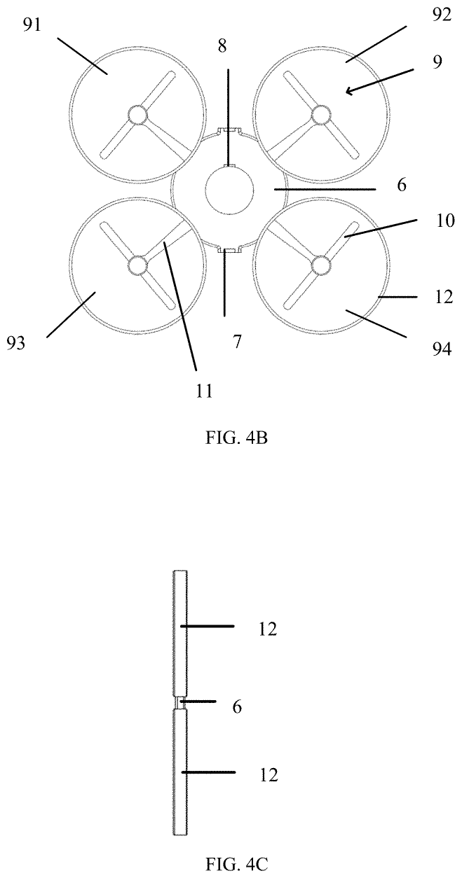

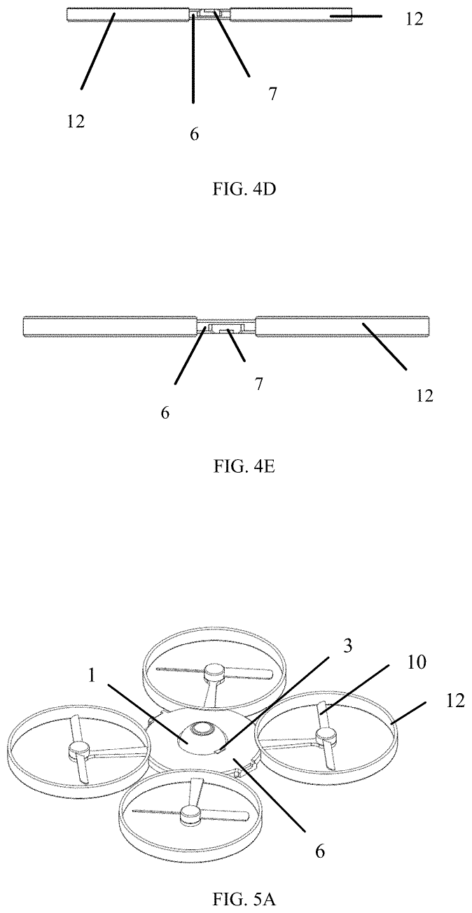

FIGS. 3A-3G show details about the panoramic camera module. FIGS. 4A-4E show details about the UAV.

FIGS. 3A-3G are schematic diagrams showing a panoramic camera 1 according to some embodiments of the present disclosure.

FIG. 3A is a schematic diagram showing the perspective view of the panoramic camera according to some embodiments of the present disclosure.

The panoramic camera 1 illustrated in FIG. 3A has an approximately sphere shape. An upper lens 2 is provided at an upper end of the panoramic camera 1. A camera connector 3 is provided at the periphery of the panoramic camera 1. As shown in FIG. 3A, the camera connector 3 is a protrusion protruding from the periphery of the panoramic camera 1.

FIG. 3B is a schematic diagram showing a front view of the panoramic camera 1 according to some embodiments of the present disclosure. The upper lens 2 and the camera connector 3 of the panoramic camera 1 are shown in FIG. 3B.

FIG. 3C is a schematic diagram showing a rear view of the panoramic camera 1 according to some embodiments of the present disclosure. A lower lens 4 and the camera connector 3 of the panoramic camera 1 are shown in FIG. 3C.

FIG. 3D is a schematic diagram showing a left view of the panoramic camera 1 according to some embodiments of the present disclosure. The upper lens 2, the lower lens 4, and the camera connector 3 of the panoramic camera 1 are shown in FIG. 3D.

FIG. 3E is a schematic diagram showing a right view of the panoramic camera 1 according to some embodiments of the present disclosure. The upper lens 2, the lower lens 4, and the camera connector 3 of the panoramic camera 1 are shown in FIG. 3E.

FIG. 3F is a schematic diagram showing a top view of the panoramic camera 1 according to some embodiments of the present disclosure. The upper lens 2, the lower lens 4, and the camera connector 3 of the panoramic camera 1 are shown in FIG. 3F.

As shown in FIG. 3D, FIG. 3E, and FIG. 3F, the camera connector 3 does not protrude outward from position at the periphery of the panoramic camera 1 with a maximum outer radius, but protrudes radially outward from a position slightly offset toward the upper lens 2. This arrangement is merely exemplary, but not exclusive. In other embodiments, the camera connector 3 may also protrude outward from any position at the periphery of the panoramic camera 1.

FIG. 3G is a schematic diagram showing a bottom view of the panoramic camera according to some embodiments of the present disclosure. The upper lens 2 and lower lens 4 of the panoramic camera 1 are shown in FIG. 3G.

The panoramic camera 1 of the present disclosure includes two lenses, the upper lens 2 and the lower lens 4, that are arranged 180° opposite to each other.

The arrangement of the panoramic camera 1 with two lenses arranged 180° opposite to each other described above is merely exemplary but not exclusive. In other embodiments, the panoramic camera 1 may include three or more lenses, or a plurality of panoramic cameras 1 may be provided.

The panoramic camera may have a shape other than the sphere shape, such as a long strip shape, as long as the lens are provided opposite to each other. The field of view of each lens needs to be larger than 180° in theory. For example, the field of view of each lens can be above 200°.

As shown in FIGS. 3A-3G, a light axis of the upper lens 2 and a light axis of the lower lens 4 of the panoramic camera 1 are arranged 180° relative to each other.

The panoramic camera 1 is roughly spherical. In some embodiments, the panoramic camera 1 may be roughly rectangular, cylindrical, etc.

The panoramic camera 1 includes an upper surface and a lower surface. The upper lens 2 is arranged on the upper surface of the panoramic camera 1, and the lower lens 4 is arranged on the lower surface of the panoramic camera 1.

The panoramic camera 1 includes the camera connector 3. The panoramic camera module may be detachably mounted to a main body of a UAV via the camera connector 3.

In some embodiments, the camera connector 3 of the panoramic camera 1 may protrude radially outward from a side surface of the panoramic camera 1.

In other embodiments, the camera connector 3 of the panoramic camera 1 may be arranged with an offset from a center axis of the panoramic camera on the side surface of the panoramic camera 1.

FIGS. 4A-4E are schematic diagrams showing a UAV 5 according to some embodiments of the present disclosure.

FIG. 4A is a schematic diagram showing a perspective view of the UAV 5. The UAV 5 includes a main body 6 (also referred to as a “UAV main body”) and four rotors 9 mounted at the main body 6. The main body 6 has a plate-shaped structure. In some embodiments, a recessed opening is provided at an edge of an accommodation hole of the main body 6 and is used as an inner periphery connector 8 of the main body 6. At an outer periphery of the main body 6, an outer periphery connector 7 is provided at each of a front end and a rear end of the UAV 5 in a front-rear flight direction of the UAV 5. In some embodiments, the accommodation hole may be provided at the center of the main body 6 and penetrate the upper surface and the lower surface. In some other embodiments, the accommodation hole may be provided not at the center of the main body 6, but at a position with an offset forward or backward from the center of the main body 6.

Each of the rotors 9 includes a connection arm 11, a propeller 10, and a propeller guard 12. An end of the connection arm 11 is connected to an outer circular periphery surface of the main body 6. The connection arm 11 extends radially outward from the outer circular periphery surface of the main body 6. The propeller 10 is arranged at the other end of the connection arm 11. The propeller guard 12 is arranged around the propeller 10. As shown in FIG. 4A, the propeller guard 12 is circular. The other end of the connection arm 11 provided with the propeller 10 is located at the center of the propeller guard 12. The propeller guard 12 may also have another suitable shape, for example, an unclosed circle, etc. The propeller guard 12 is configured to prevent a danger caused by rotation of the propeller 10.

Referring to FIG. 4B, four rotors 9 as a whole form a ring shape and are arranged with intervals along the outer periphery of the main body 6. The number of rotors 9 may be 2, 3, 4, or more. Distances between adjacent rotors 9 may vary, may be the same, or may be different. In the embodiment shown in FIG. 4B, the four rotors 9 include a first rotor 91, a second rotor 92, a third rotor 93, and a fourth rotor 94. A distance between the first rotor 91 and the second rotor 92 is almost equal to a distance between the third rotor 93 and the fourth rotor 94. A distance between the first rotor 91 and the third rotor 93 is almost equal to a distance between the second rotor 92 and the fourth rotor 94. However, a distance between the first rotor 91 and the second rotor 92 is longer than a distance between the first rotor 91 and the third rotor 93. As such, a space is reserved for accommodating the panoramic camera 1 between the first rotor 91 and the second rotor 92, and between the third rotor 93 and the fourth rotor 94.

FIG. 4C is a schematic diagram showing a left view of the UAV 5 according to some embodiments of the present disclosure. FIG. 4C illustrates the propeller guards 12 of the rotors 9 and the main body 6.

FIG. 4D is a schematic diagram showing a front view of the UAV 5 according to some embodiments of the present disclosure. FIG. 4D illustrates the propeller guards 12 of the rotors 9 and the outer periphery connector 7 of the UAV 5.

FIG. 4E is a schematic diagram showing a rear view of the UAV 5 according to some embodiments of the present disclosure. FIG. 4E illustrates the propeller guards 12 of the rotors 9 and the outer periphery connector 7 of the UAV 5.

The plurality of rotors 9 of the UAV 5 are ring-shaped. The rotors 9 may be connected to the main body 6 by welding or another connection means.

Referring to FIGS. 4A-4E, the UAV 5 includes the four rotors 9.

In some other embodiments, the plurality of rotors 9 may be arranged along the periphery at equal intervals around the center of the main body 6.

Referring to FIGS. 4A-4E, each rotor 9 includes the connection arm 11. An end of the connection arm 11 is connected to the outer circular periphery surface of the main body 6. The connection arm 11 extends radially outward from the outer circular periphery surface of the main body 6. The propeller 10 is arranged at the other end of the connection arm 11.

The rotor 9 is ring-shaped. The other end of the connection arm 11 provided with the propeller 10 is arranged at the center of the rotor 9.

Referring to FIGS. 4A-4E, the main body 6 and the rotors 9 are approximately on a same horizontal plane. The main body 6 and the propellers 10 are approximately on a same horizontal plane.

The accommodation hole is provided at the main body 6. The panoramic camera 1 is arranged in the accommodation hole of the main body 6. The main body 6 may have an approximately plate-shaped structure, an approximately circular structure, or a polygonal structure.

The main body 6 includes an inner periphery connector 8. The panoramic camera 1 includes a camera connector 3. The panoramic camera 1 is connected to the main body 6 through a cooperation between the camera connector 3 and the inner periphery connector 8 of the main body 6.

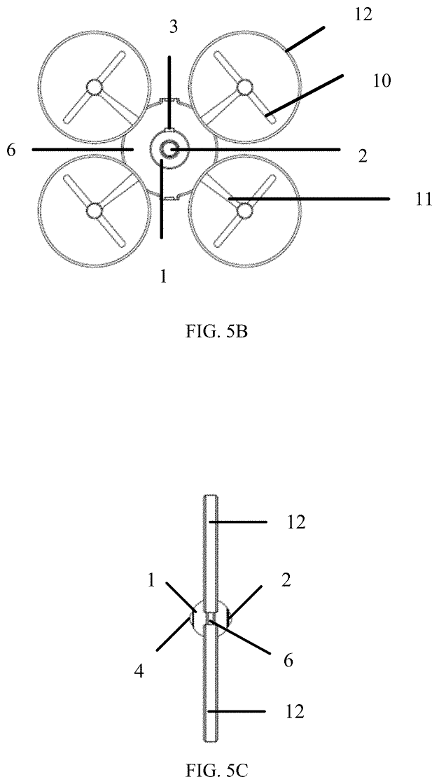

FIGS. 5A-5D are schematic diagrams showing a panoramic camera module mounted at the accommodation hole of a main body of a UAV according to some embodiments of the present disclosure. The panoramic camera module can be, e.g., the above-described panoramic camera 1 and the UAV can be, e.g., the UAV 5.

FIG. 5A is a schematic diagram showing a perspective view of the UAV 5 with the panoramic camera 1 mounted at the accommodation hole of the main body 6 according to some embodiments of the present disclosure. As shown in FIG. 5A, through the cooperation between the camera connector 3 provided at the panoramic camera 1 and the inner periphery connector 8 at the inner periphery of the main body 6, the panoramic camera 1 is mounted at the accommodation hole of the main body 6. Mounting the panoramic camera 1 at the center of the main body 6 is beneficial for setting the center of gravity for the whole UAV.

FIG. 5B is a schematic diagram showing a top view of the UAV 5 with the panoramic camera 1 mounted at the accommodation hole of the main body 6 according to some embodiments of the present disclosure. FIG. 5B illustrates that the panoramic camera 1 is mounted at the accommodation hole of the main body 6. The upper lens 2 of the panoramic camera 1 is arranged on the upper surface of the panoramic camera 1 and protrudes upward. FIG. 5B illustrates the four rotors 9. Each of the rotors 9 includes the connection arm 11, the propeller 10, and the propeller guard 12.

FIG. 5C is a schematic diagram showing a left view of the UAV 5 with the panoramic camera module mounted 1 at the accommodation hole of the main body 6 according to some embodiments of the present disclosure. FIG. 5C illustrates that the panoramic camera 1 is mounted at the accommodation hole of the main body 6. The upper lens 2 of the panoramic camera 1 is arranged on the upper surface of the panoramic camera 1 and protrudes upward from the upper surface of the main body 6, i.e., protruding to the right as seen in the left view. The lower lens 4 of the panoramic camera 1 is arranged on the lower surface of the panoramic surface module 1 and protrudes downward from the lower surface of the main body 6, i.e., protruding to the left as seen in the left view.

FIG. 5D is a schematic diagram of a front view of the UAV 5 with the panoramic camera 1 mounted at the accommodation hole of the main body 6 according to some embodiments of the present disclosure. FIG. 5D illustrates that the panoramic camera 1 is mounted at the accommodation hole of the main body 6. The upper lens 2 of the panoramic camera 1 is arranged on the upper surface of the panoramic camera 1 and protrudes upward from the upper surface of the main body 6, i.e., protruding upward as seen in the front view. The lower lens 4 of the panoramic camera 1 is arranged at the lower surface of the panoramic surface module 1 and protrudes downward from the lower surface of the main body 6, i.e., protruding downward as seen in the front view.

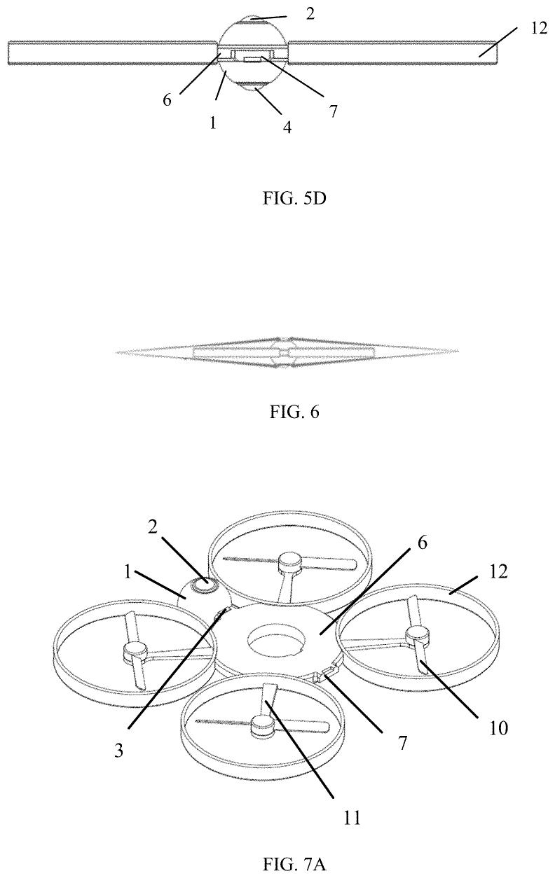

FIG. 6 is a schematic diagram showing the UAV 5 mounted with the panoramic camera 1 of FIGS. 5A-5D, where a path of light entering the panoramic camera module is shown. Since the panoramic camera 1 is arranged at the center of the UAV 5, an incident angle of the light entering the panoramic camera 1 from the front of the UAV 5 and an incident angle of the light entering the panoramic camera 1 from the rear of the UAV 5 may be approximately equal.

In some embodiments, the main body 6 may include an outer periphery connector 7. The panoramic camera 1 includes a camera connector 3. The panoramic camera 1 is connected to the main body 6 through the cooperation between the camera connector 3 and the outer periphery connector 7.

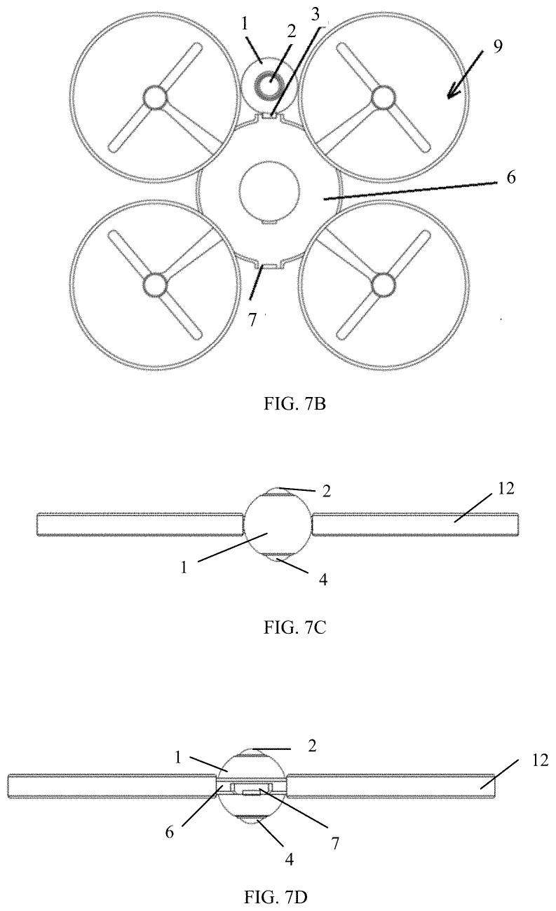

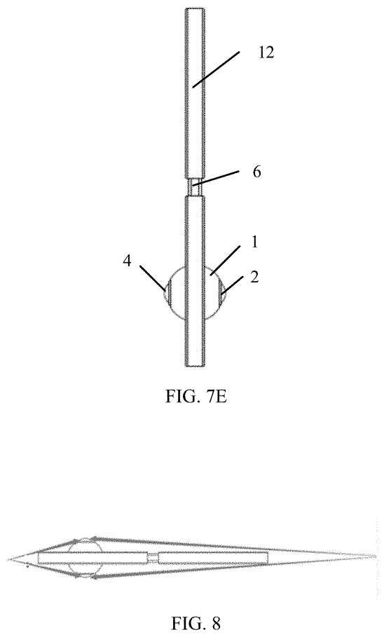

FIGS. 7A-7E are schematic diagrams showing a panoramic camera module mounted at the outer periphery of a main body of a UAV according to some embodiments of the present disclosure. The panoramic camera module can be, e.g., the above-described panoramic camera 1 and the UAV can be, e.g., the UAV 5.

FIG. 7A is a schematic diagram showing a perspective view of the UAV 5 with the panoramic camera 1 mounted at the outer periphery of the main body 6 according to some embodiments of the present disclosure. The main body 6 has an approximately circular structure. At the outer periphery of the main body 6, an outer periphery connector 7 is arranged at each of the front end and rear end of the UAV in the front-rear flight direction. Through the cooperation between the camera connector 3 arranged in the panoramic camera 1 and the outer periphery connector 7 arranged at the outer periphery of the main body of the UAV, the panoramic camera 1 is mounted at the front end of the main body 6.

In other embodiments, the outer periphery connector 7 may be arranged at the rear end of the main body 6 in the flight direction. The panoramic camera 1 may be arranged at the rear end of the main body 6 in the flight direction.

In other embodiments, the outer periphery connector 7 may be arranged at each of the front end and rear end of the main body 6 in the flight direction. As such, the panoramic camera 1 may be arranged at each of the front end and rear end of the main body 6 in the flight direction.

As shown in FIG. 7A, the outer periphery connectors 7 are arranged at both front end and rear end of the main body 6 in the flight direction, which are exemplary. In other embodiments, the outer periphery connector 7 may only be arranged at the front end of the main body 6 in the flight direction, and may not be arranged at the rear end of the main body 6 in the flight direction.

FIG. 7B is a schematic diagram showing a top view of the UAV 5 with the panoramic camera 1 mounted at the outer periphery of the main body 6 according to some embodiments of the present disclosure. Through the cooperation between the camera connector 3 arranged in the panoramic camera 1 and the outer periphery connector 7 arranged at the outer periphery of the main body 6, the panoramic camera 1 is mounted at the front end of the main body 6. The upper lens 2 of the panoramic camera 1 is arranged on the upper surface of the panoramic module 1 and protrudes upward from the upper surface of the main body 6.

FIG. 7C is a schematic diagram showing a front view of the UAV 5 with the panoramic camera 1 mounted at the outer periphery of the main body 6 according to some embodiments of the present disclosure. The upper lens 2 of the panoramic camera 1 is arranged on the upper surface of the panoramic module 1 and protrudes upward from the upper surface of the main body 6. The lower lens 4 of the panoramic camera 1 is arranged on the lower surface of the panoramic camera 1 and protrudes downward from the lower surface of the main body 6.

FIG. 7D is a schematic diagram showing a rear view of the UAV 5 with the panoramic camera 1 mounted at the outer periphery of the main body 6 according to some embodiments of the present disclosure. FIG. 7E is a schematic diagram showing a left view of the UAV 5 with the panoramic camera 1 mounted at the outer periphery of the main body 6 according to some embodiments of the present disclosure.

The UAV 5 includes the plurality of rotors 9. The plurality of rotors 9 are connected to the main body 6. The panoramic camera 1 is arranged at the outer periphery of the main body 6 and between any two rotors of the plurality of rotors 9.

FIG. 8 is a schematic diagram showing the UAV 5 mounted with the panoramic camera 1 in FIGS. 7A-7E, where a path of light entering the panoramic camera 1 is shown. As shown in FIG. 8, the upper lens 2 of the panoramic camera 1 is arranged on the upper surface of the panoramic camera 1 and protrudes upward from the upper surface of the main body 6. The lower lens 4 of the panoramic camera 1 is arranged on the lower surface of the panoramic camera 1 and protrudes downward from the lower surface of the main body 6. Since the panoramic camera 1 is arranged at the front end of the UAV 5, the incident angle of the light entering the panoramic camera 1 from the front of the UAV 5 is larger than the incident angle of the light entering the panoramic camera 1 from the rear of the UAV 5.

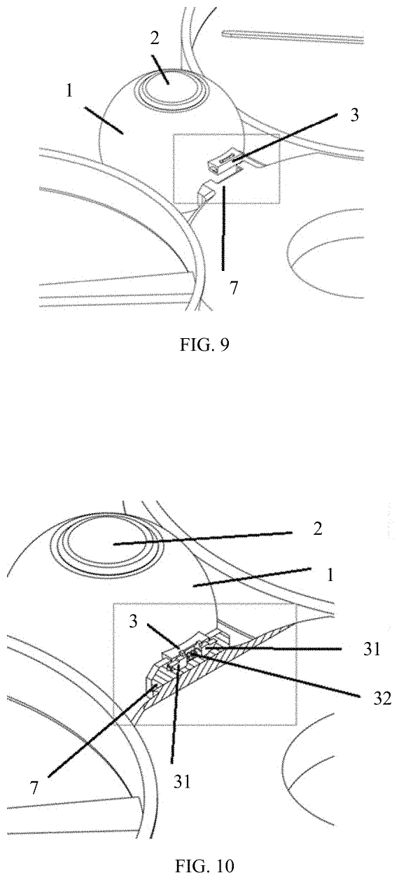

FIG. 9 is a partial enlarged view showing a state of the panoramic camera 1 before being connected to the main body 6 according to some embodiments of the present disclosure.

The panoramic camera 1 may be connected to the main body 6 using one of a plurality of connection means, for example, a permanently fixed connection, and a detachable connection. The connection means shown in FIG. 9 and FIG. 10 are exemplary, not exclusive.

As shown in FIG. 9, the camera connector 3 of the panoramic camera 1 corresponds to the outer periphery connector 7 of the main body 6. A protrusion is provided at the camera connector 3 of the panoramic camera 1. A recessed portion is provided at the outer periphery of the main body 6 which corresponds to the protrusion. The protrusion of the camera connector 3 is arranged in the recessed portion of the outer periphery connector 7 of the main body 6 to realize the connection.

FIG. 10 is a partial enlarged view showing a portion of FIG. 9 being further enlarged, and shows a structure when the panoramic camera 1 is connected to the main body 6.

As shown in FIG. 10, a quick connection-disconnection structure is arranged in the protrusion of the camera connector 3. Through the quick connection-disconnection structure, the connection-disconnection between the panoramic camera and the UAV may be realized. The quick connection-disconnection structure is merely exemplary, not exclusive. As shown in FIG. 10, the quick connection-disconnection structure includes a pair of sliding members 31 and an elastic member 32 between the sliding members 31.

When the protrusion of the camera connector 3 is inserted in the recessed portion of the outer periphery connector 7 of the main body 6, the pair of the sliding members 31 arranged in the protrusion of the camera connector 3 may slide into a locking hole of the recessed portion of the outer periphery connector 7 of the main body 6 through a function of the elastic member 32. As such, the panoramic camera 1 may be connected to the UAV.

To disconnect the panoramic camera 1 from the UAV 5, an elastic force of the elastic member 32 needs to be overcome to cause the pair of sliding members 31 arranged in the protrusion of the camera connector 3 to slide in the locking hole of the recessed portion of the outer periphery connector 3 arranged at the main body 6.

The panoramic camera 1 may be detachably mounted at at least one of the accommodation hole or the outer periphery of the main body 6 through the camera connector 3. That is, a plurality of panoramic camera modules 1 may be included. The plurality of panoramic camera modules 1 may be mounted in the accommodation hole and at the front end and rear end at the outer periphery of the main body 6 along the front and rear direction of the flight, respectively.

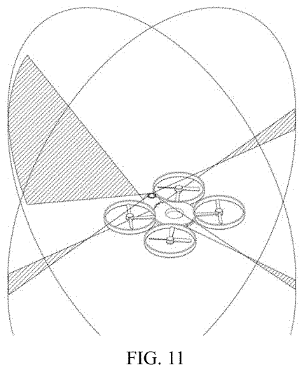

FIG. 11 is a schematic diagram showing the visual obstacle avoidance. Portions in FIG. 11 with hatched lines indicate unblocked areas with visual overlap. If a panoramic camera is arranged at a front end of the UAV, the forward overlapping area becomes larger, which is beneficial to binocular vision obstacle avoidance.

Similarly, if the panoramic camera is arranged at a rear end of the UAV, the backward overlapping area may become larger, which may be beneficial to the binocular vision obstacle avoidance.

In some embodiments, two panoramic cameras may be arranged at the front end and the rear end, respectively, of the UAV. Therefore, the forward and backward overlap areas may become larger, which may be beneficial to the binocular vision obstacle avoidance.

After the UAV is combined with the panoramic camera, the field of view is not blocked, and the mechanical gimbal may be removed, such that an omnidirectional view may be obtained. The advantage of this solution may include performing photographing at first and then performing view finding, never losing a followed object, and after monocular obstacle avoidance becomes mature, obtaining an ability of omnidirectional obstacle avoidance.

Those skilled in the art can understand that the features described in the various embodiments of the present disclosure and/or the claims can be grouped and/or combined in various ways, even if such groups or combinations are not explicitly described in the present disclosure. In particular, without departing from the spirit and teaching of the present disclosure, the various embodiments of the present disclosure and/or the features thereof can be grouped and/or combined in various ways. All these groups and/or combinations are within the scope of the present disclosure.

Although the present disclosure is shown and described with reference to specific exemplary embodiments of the present disclosure, those skilled in the art should understand that without departing from the spirit and scope of the present disclosure defined by the appended claims and their equivalents, various changes in form and details may be made to the present disclosure. Therefore, the scope of the present disclosure should not be limited to the above-described embodiments. The scope of the invention is defined not only by the appended claims but also by equivalents of the appended claims.

What is claimed is:

1. An unmanned aerial vehicle (UAV) comprising:
a main body including an upper surface and a lower surface, an accommodation hole being provided at the main body and penetrating the upper surface and the lower surface; and
a panoramic camera including:
a camera connector detachably mounting the panoramic camera to at least one of the accommodation hole or an outer periphery of the main body;
an upper lens arranged above the upper surface of the UAV; and
a lower lens arranged below the lower surface of the UAV.

2. The UAV of claim 1, wherein the accommodation hole is provided at a center of the main body.

3. The UAV of claim 1, wherein the accommodation hole is provided at a position with an offset forward or backward from a center of the main body along a flight direction.

4. The UAV of claim 1, wherein:
an inner periphery connector is provided at the accommodation hole; and
the panoramic camera is connected to the main body through a cooperation between the camera connector and the inner periphery connector.

5. The UAV of claim 1, wherein:
an outer periphery connector is provided at the outer periphery of the main body; and
the panoramic camera is connected to the main body through a cooperation between the camera connector and the outer periphery connector.

6. The UAV of the claim 5, wherein the outer periphery connector is provided at a front end in a flight direction of the main body to cause the panoramic camera to be connected at the front end in the flight direction of the main body through the camera connector.

7. The UAV of claim 5, wherein the outer periphery connector is provided at a rear end in a flight direction of the main body to cause the panoramic camera to be connected at the rear end in the flight direction of the main body through the camera connector.

8. The UAV of claim 5, wherein:
the panoramic camera is one of two panoramic cameras of the UAV and the outer periphery connector is one of two outer periphery connectors of the main body;
one of the outer periphery connectors is provided at a front end in a flight direction of the main body to cause one of the panoramic cameras to be connected at the front end in the flight direction of the main body through the camera connector of the one of the panoramic cameras; and
another one of the outer periphery connectors is provided at a rear end in the flight direction of the main body to cause another one of the panoramic cameras to be connected at the rear end in the flight direction of the main body through the camera connector of the another one of the panoramic cameras.

9. The UAV of claim 1, wherein:
the UAV includes a plurality of rotors connected to the main body; and
the panoramic camera is arranged at the outer periphery of the main body and between two rotors of the plurality of rotors.

10. The UAV of claim 9, wherein the plurality of rotors of the UAV form a ring shape.

11. The UAV of claim 9, wherein each of the plurality of rotors includes:
a connection arm, one end of the connection arm being connected to an outer periphery surface of the main body, and the connection arm extending outward from the outer periphery surface of the main body;
a propeller arranged at another end of the connection arm; and
a propeller guard arranged around the propeller.

12. The UAV of claim 11, wherein the main body of the UAV and the plurality of rotors are approximately in a same horizontal plane.

13. The UAV of claim 1, wherein an optical axis of the upper lens and an optical axis of the lower lens are arranged 180° opposite to each other.

14. The UAV of claim 1, wherein:
the panoramic camera includes an upper surface and a lower surface; and
the upper lens is arranged on the upper surface of the panoramic camera, and the lower lens is arranged on the lower surface of the panoramic camera.

15. The UAV of claim 1, wherein the camera connector of the panoramic camera protrudes outward radially from a side surface of the panoramic camera.

16. The UAV of claim 1, wherein the camera connector of the panoramic camera is arranged on a side surface of the panoramic camera with an offset from a center axis of the panoramic camera.

17. The UAV of claim 1, wherein:
the camera connector includes a quick connection-disconnection structure; and
the quick connection-disconnection structure includes a pair of sliding members and an elastic member arranged between the pair of sliding members.

18. The UAV of claim 17, wherein:
the main body includes an outer periphery connector including a locking hole; and
the elastic member is configured to drive the pair of sliding members to slide into the locking hole when the camera connector is at a right position of the outer periphery connector.

19. The UAV of claim 17, wherein:
the main body includes an outer periphery connector including a locking hole; and
the panoramic camera is configured to be disconnected from the UAV by overcoming an elastic force of the elastic member to cause the pair of sliding members to slide in the locking hole.

20. An unmanned aerial vehicle (UAV) comprising:
a main body including an upper surface and a lower surface; and
a panoramic camera including:
a camera connector detachably mounting the panoramic camera to an outer periphery of the main body;
an upper lens arranged above the upper surface of the UAV; and
a lower lens arranged below the lower surface of the UAV.
